(19) United States
(12) Patent Application Publication
(10) Pub. No.: US 2015/0149239 A1
(43) Pub. Date: May 28, 2015

(54) Technology Element Risk Analysis

(71) Applicant: International Business Machines Corporation, Armonk, NY (US)

(72) Inventors: Karl O. Casserly, Valley Stream, NY (US); Bohdan Demczar, Hyde Park, NY (US); James I. Paradies, Clintondale, NY (US); John G. Torok, Poughkeepsie, NY (US)

(73) Assignee: International Business Machines Corporation, Armonk, NY (US)

(21) Appl. No.: 14/087,097

(22) Filed: Nov. 22, 2013

(51) Int. Cl. G06Q 10/06

(52) U.S. Cl. CPC G06Q 10/0635
USPC 705/7.28

(57) ABSTRACT

A quantitative approach to analytically assess technical elements within a system design. Numerical analysis and sorting is performed across the technical elements. Risk analysis is performed by evaluating criteria and ranking the evaluated criteria. The ranking criteria are placed into groups, with the groups identifying area that will be mitigated against risk.

### BACKGROUND

### Technical Field

The present invention relates to a quantitative approach to analytically assess technical elements within a system design. More specifically, the invention relates to identification of functional elements within the design, and ranking the elements against a set of criteria to identify one or more risk areas.

Development of new products is often viewed as an evolution from prior products in that new product development commonly borrows aspects from prior products. At the same time, all products, whether new or old, have some risk associated therewith. The risk may be a part of manufacture, product liability, or design. Current risk assessment pertains to a qualitative assessment. However, such assessments do not account for quantifying the risks. Specifically, current assessment for new products do not account for focusing priorities, and for addressing the assessment in the design stage.

### SUMMARY OF THE INVENTION

This invention comprises a method, system, and computer program product for quantifying risk assessment associated with new product development.

A method, computer program product, and system are provided for performing element risk analysis of a product entity. One or more functional items that comprise the entity are identified, and evaluated against criteria. A numerical value is assigned to each of the evaluated criteria. In addition, based on the numerical assignment, a risk priority number is assessed for each of the identified functional items. The risk priority number is based on a combination of the numerical value for each of the plurality of criteria for each functional item. Each of the functional items is ranked based on the risk priority number. The aspect of ranking includes sorting the functional items. An inclusive view of risk associated with the product entity is provided by categorizing the elements into groups and from these groups identifying one or more areas for risk mitigation.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a flow chart depicting a process for product risk assessment.

FIG. 2 is a flow chart depicting a process for calculating risk priority numbers (RPNs).

FIG. 3 is a flow chart depicting a process for analyzing risks based on the RPNs.

FIG. 4 is a block diagram of a sample matrix for technology element risk analysis.

FIG. 5 is a block diagram depicting a system for risk assessment.

FIG. 6 is a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit described in this specification has been labeled with tools, modules, and/or managers. The functional unit may be implemented in programmable hardware devices such as field programmable gate arrays, programmable array logic, programmable logic devices, or the like. The functional unit may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of managers, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing from the scope of the present invention.

A quantitative approach is provided to analytically assess risk of functional elements within a system design. Each of the functional elements is identified and ranked against criteria. In one embodiment, there are a total of five criteria, including: technology risk, complexity of design, design skills and team work knowledge, customer impact, and field performance. Although specific criteria have been identified, in one embodiment, this quantity should not be considered limiting. For each functional element and each of the criteria, data is gathered and risks are evaluated. In one embodiment, the evaluation is based on historical data that is employed to extrapolate a future prediction.

As each of the functional items is ranked against a specific criterion, a numerical value is assigned to each criterion. A result of the criteria assignments yields a risk priority number, which in one embodiment functions as a combination of the individual risks of each functional element and each identified criteria. More specifically, the risk is quantitatively assigned a numerical value based on a combination of the numerical values assigned to each of the criteria. In one embodiment, a higher risk priority number is indicative of volatility in the new product design. Once the rank is established, each of the functional elements are categorized into groups to identify one or more areas for risk mitigation. Accordingly, an inclusive view of product risk is provided, with the risk based on data analytics and objective criteria.

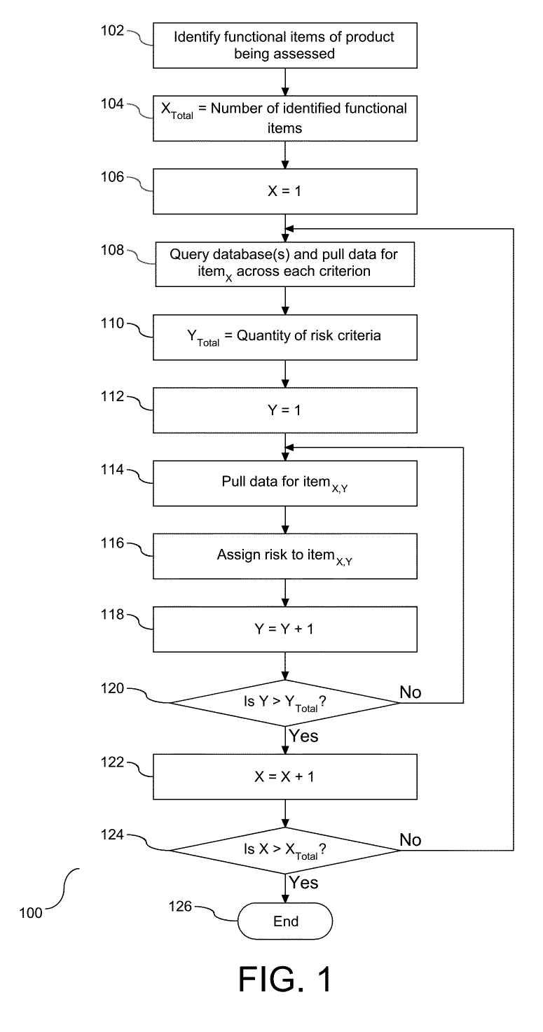

FIG. 1 is a flow chart (100) depicting a process for product risk assessment. There are four phases to the assessment. The first phase pertains to development, and specifically product development. Each product in development is defined, and generally includes subcomponents and associated technology. The first phase identifies the functional items of the product being assessed (102). In one embodiment, the product definition is one of the functional items, each subcomponent is assigned as a separate functional item, and the associated technology is assigned as another separate functional item. Accordingly, each product under consideration has a minimum of three functional items that are identified for evaluation.

Following step (102), data is gathered from one or more databases for each of the identified functional items. In one embodiment, the variable X_{Total} is assigned to the quantity of identified functional items (104), with an initialization of an associated counting variable, X, (106). For each functional item, item_{X}, one or more databases are queried to pull data for the respective item across each criterion (108). In one embodiment, each of the identified criteria, the data for the criteria is embedded in separate databases, and the pulling of data requires communication with the separate database(s). The variable Y_{Total} is assigned to the quantity of risk criteria (110), and an associated risk criteria counting variable Y is initialized (112). Data is pulled and employed for evaluation of the item in a specified category, item_{X, Y}, (114), after which a risk is assigned to the item_{X,Y} (116). Accordingly, each separate functional item in each category is assigned a separate risk.

Each functional item in each category may have one risk factor assigned from a grouping of risk factors. In one embodiment, each category has a selection of three risk factors, although the quantity is for illustrative purposes and should not be considered limiting. In the technology risk category, the categories in hierarchical order include: new, evolutionary, and pick-up. For the impact of design complexity, the categories in hierarchical order include difficulty to manufacture, special training requirement, and easy to manufacture. In one embodiment, the difficulty to manufacture may be associated with quantity of components and special tool requirement(s). For the design skills, the categories in hierarchical order include no experience, some experience, and previously designed. For the customer impact, the categories in hierarchical order: include unscheduled outage, scheduled outage performance, and concurrent repair action. Finally, for field performance, the categories include: defects high above target fallout, above target fallout, and defects below target fallout. Each of the risk factors and their associated categories are quantified by assignment of a numerical value.

Following the risk assignment, the item counting variable Y associated with the risk category is incremented (118), after which it is determined if each of the risk categories have been assessed for item_{X} (120). A negative response to the determination at step (120) is followed by a return to step (114), and a positive response to the determination at step (120) concludes the risk assessment(s) across each of the defined risk categories for an identified item. Following a negative response to the determination at step (120), the item counting variable X is incremented (122). It is then determined if each of the identified functional items has been assessed for each of the identified risk categories (124). A negative response to the determination at step (124) is followed by a return to step (108) for continued evaluation, and a positive response to the determination at step (124) concludes the initial evaluation (126). Accordingly, the first part of the product risk assessment includes identification of functional items, together with separate evaluation of each item.

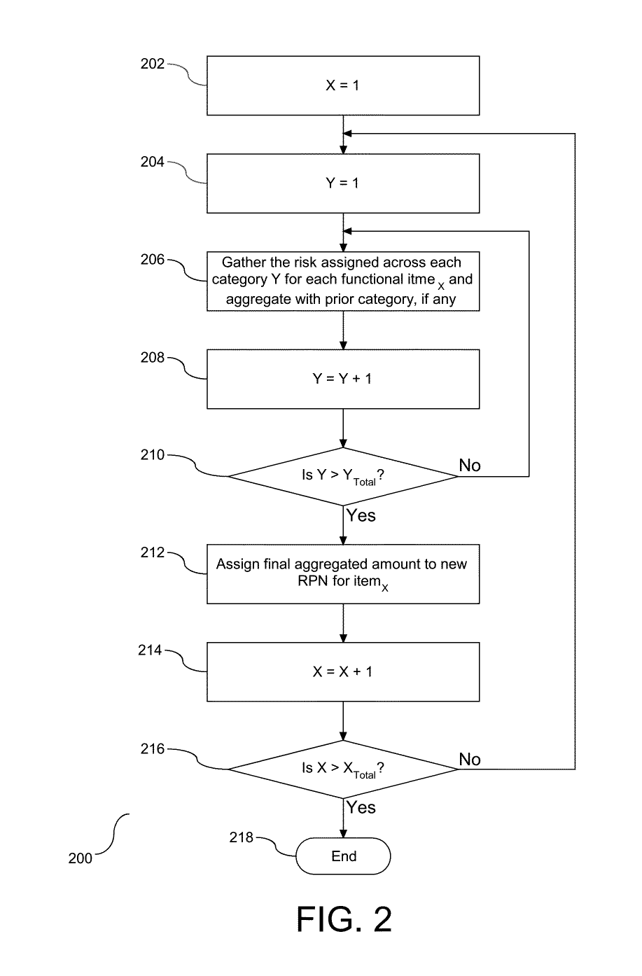

Following the risk assignment for each item in each category, a risk priority number (RPN) is calculated. FIG. 2 is a flow chart (200) illustrates the process for RPN calculation. More specifically, the RPN is a cumulative data value for each identified functional item across the identified risk criteria. Each functional item has one cumulative RPN. The functional item counting variable X is initialized (202), and the risk assignment category counting variable Y is initialized (204). For each functional item_{X}, the risk assigned across each category Y is gathered (206). The counting variable for the category is incremented (208), and it is assessed whether there are additional categories to be gathered (210). If there are additional categories, the next category is gathered and aggregated with the prior category, as shown with a return to step (206). Conversely, if there are no additional categories, the final aggregated amount is assigned to the new RPN for item_{X} (212). This process continues for each of the functional items. As shown, following step (212), the functional item counting variable X is incremented (214), followed by a determination if all of the functional items have been evaluated (216). If any functional items remain for evaluation, the process returns to step (204). Conversely, if all of the functional items have been evaluated, then the processing of aggregating the new RPN concludes (218).

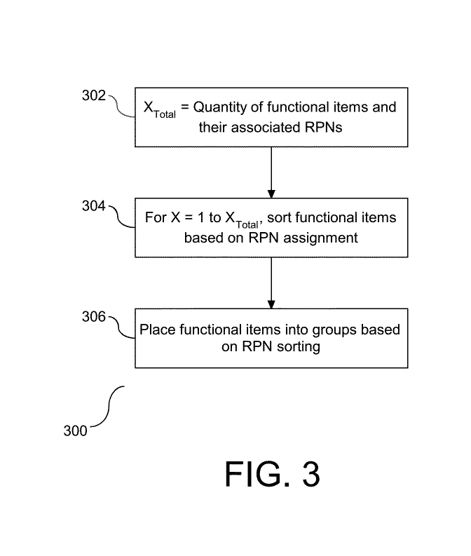

The functional items are assessed based upon the aggregated RPNs. FIG. 3 is a flow chart (300) illustrating a process for analyzing risks based on the RPNs. The variable X_{Total} is assigned to the quantity of functional items, and their associated RPNs (302). The functional items are sorted based on the RPN assignment (304). In one embodiment, the sorting is from the highest RPN to the lowest RPN. The functional items are placed into groups based upon their RPN sorting (306). In one embodiment, the group assignments are based upon a distribution of RPNs. For example, in an embodiment with three groups of RPNs, those RPNs with a high number as part of the assessment evaluation may be assigned to a higher group, thereby gathering focus for high risk assessment and evaluation.

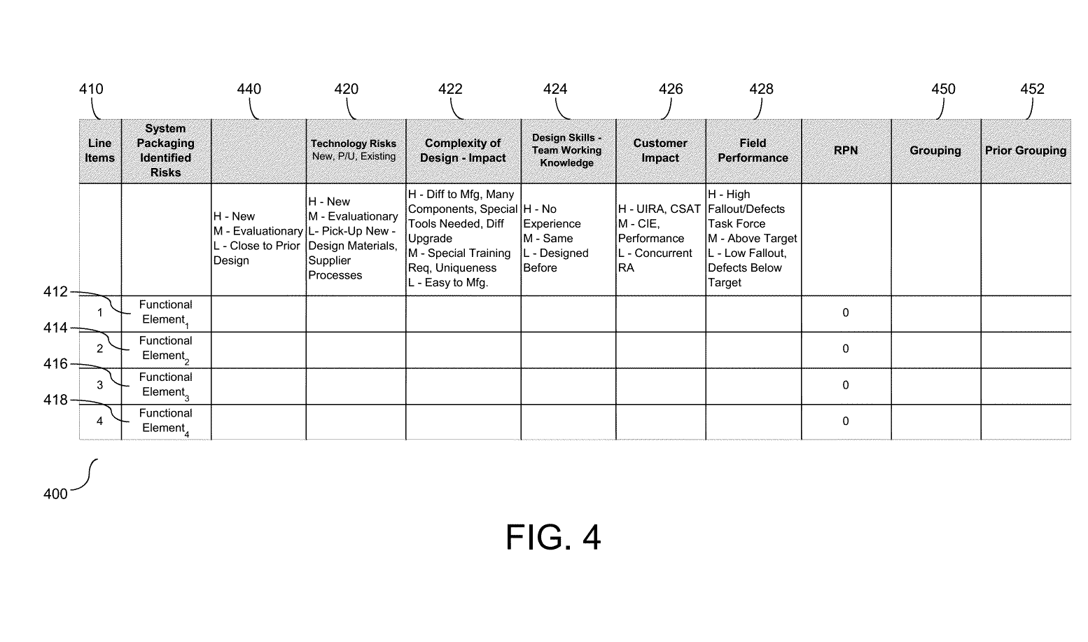

In one embodiment, the compilation of the functional items and the risk criteria assignment are organized in a matrix. FIG. 4 is a block diagram (400) of a sample matrix. As shown, the functional items (412), (414), (416), and (418) are organized on a horizontal axis (410), and the risk categories (420), (422), (424), (426), and (428) are organized on a vertical axis (430). Although the sample matrix is limited to four functional items and five risk categories, neither of these quantities should be considered limiting, and in one embodiment, the quantities may vary. Each risk category for each functional item is assigned risk criteria. Each risk category is shown to have three levels of risk, of which one level is assigned to the associated functional item. In addition and as explained in FIG. 3, a risk priority number is assessed across all of the risk categories and associated criteria for each functional item. Accordingly, the RPN is a cumulative value across the risk criteria for each functional item.

As shown in FIG. 4, additional risk criteria (440) pertaining to the longevity of the product may be included. In this example, one of three values may be assigned to the additional criteria, including an indication that the product is a new design, an evolutionary design, or a close embodiment of a prior design. For example, a functional item that pertains to a new design may have a greater associated risk than that of an item whose design is being modified.

The functional items (412)-(418) are shown in a hierarchical representation based on the RPNs for each item. In addition, the function items may be placed into a grouping (450). Specifically, the grouping is representative of two or more items having a similar cumulative risk category. In one embodiment, the individual risk criteria may change with data or design point changes. Any one change may produce a change in the associated RPN, which may place the associated functional item into a different grouping (450). To further illustrate, an additional column (452) may be provided to indicate a prior grouping of the functional item in which the prior grouping may be the same or different from the current grouping. Accordingly, the comparison of groupings for the same functional item enables comparison of these items with respect to any changes.

In one embodiment, any one of the matrix cells shown in FIG. 4 may be drilled down for analysis. For example, a cell in the matrix may be selected to ascertain if any repair actions are taking place on a customer impact assessed as high. The drill down enables extraction of various data sets to evaluate individual functional elements.

The matrix and the associated groupings provide a venue for quantifying risk for functional items of a product, and at the same times ranks the risks so that they are expressly conveyed. In one embodiment, the matrix functions as a common tool across different organizations to assist in evaluation of common risks, e.g. standard evaluation. Similarly, in another embodiment, the matrix functions to facilitate assessment of individual risks, both comparatively and historically. The historical data, as expressed in one embodiment as the old grouping, demonstrates trends across the criteria. Accordingly, the matrix supports assessment of individual risks both historically and comparatively.

As will be appreciated by one skilled in the art, aspects of the present invention may be embodied as a system, method or computer program product. Accordingly, aspects of the present invention may take the form of an entirely hardware based embodiment, an entirely software based embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

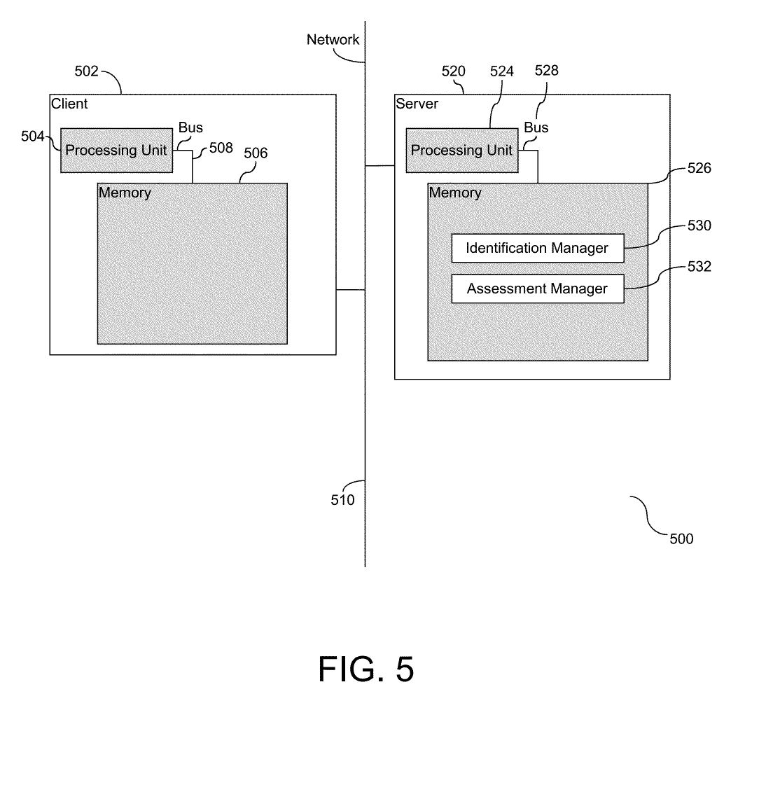

FIG. 5 is a block diagram (500) depicting a system for performing risk analysis. A client machine (502) is provided in communication with a server (520) across a network connection (510). While only a single client machine (502) is shown, it is understood that more than one client machine may be in communication with the server (520). The client machine (502) is provided with a processing unit (504) in communication with memory (506) across a bus (508). Similarly, the server (520) is provided with a processing unit (524) in communication with memory (526) across a bus (528). The processing unit (524) functions to perform processes to support risk analysis.

A set of tools is provided in communication with memory (526). The tools include, but are not limited to, an identification manager (530) and an assessment manager (532). The identification manager (530) functions to identify one or more functional items of a product that comprise an entity. In one embodiment, the entity is a product, process, or service. Once the items are identified, the manager evaluates each of the functional items against a plurality of criteria, and assigns a numerical value to each of the criteria evaluated. The assessment manager (532) functions to assess a risk priority number to each of the functional items. The risk priority number is based on a combination of the numerical value for each of the criteria for each functional item. Following the assessment of the risk priority number(s), the assessment manager (532) ranks each of the functional items based on the risk priority number. The aspect of ranking the items includes sorting the functional items based on the rank. Once the ranking is complete, an inclusive view, otherwise known as an inclusive report, of entity risk is provided by the assessment manager (532). The inclusive view is a categorization of the elements into groups and identification of at least one area for risk mitigation.

The assigning of values to each of the criteria is conducted independently. More specifically, each criterion has a separate and independent value for each identified risk area. The risk priority number is calculated based on a combination of the criteria, such that the risk priority number is subject to a dynamic change based upon a change in any one of the criteria. In one embodiment, the assessment manager (532) enables the criteria to be evaluated or re-evaluated, which may be reflected in a change of the numerical value of at least one of the criteria. The risk priority number is based on a combination of the numerical values for each of the criteria. A change on one of the numerical values includes a reassessment of the risk priority number. Each of the risk priority numbers are sorted and ranked. As any values for any one of the criteria changes, the assessment manager (532) conducts another ranking of the risk priority numbers so that the ranking is current.

The risk priority number is a combination of a plurality of risk value assigned to each criteria. Each risk value has a basis for the assignment, e.g. the risk value is not arbitrarily assigned to an associated criterion. In one embodiment, the assessment manager (532) runs a series of scripts to quantify one or more of the risks. In a further embodiment, a visual representation of the risk assessment is provided. One example of the visual representation is an inclusive view that shows both a historical assessment and a comparative assessment, with these assessments including individual risks to each of the separate functional items. Accordingly, the assessment manager (532) functions in a dynamic manner to maintain a current risk assessment.

As identified above, the identification manager (530) and assessment manager (532), hereinafter referred to as tools, function as elements to perform risk analysis. The tools (530) and (532) are shown residing in memory (526) local to the server (520). However, the tools (530) and (532) may reside as hardware tools external to memory (526), or they may be implemented as a combination of hardware and software. Similarly, in one embodiment, the tools (530) and (532) may be combined into a single functional item that incorporates the functionality of the separate items. As shown herein, each of the tools (530) and (532) are shown local to the server (520). However, in one embodiment they may be collectively or individually distributed across a network or multiple machines and function as a unit to dynamically assess and process a procurement request. Accordingly, the tools may be implemented as software tools, hardware tools, or a combination of software and hardware tools.

As will be appreciated by one skilled in the art, aspects of the present invention may be embodied as a system, method or computer program product. Accordingly, aspects of the present invention may take the form of an entirely hardware based embodiment, an entirely software based embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

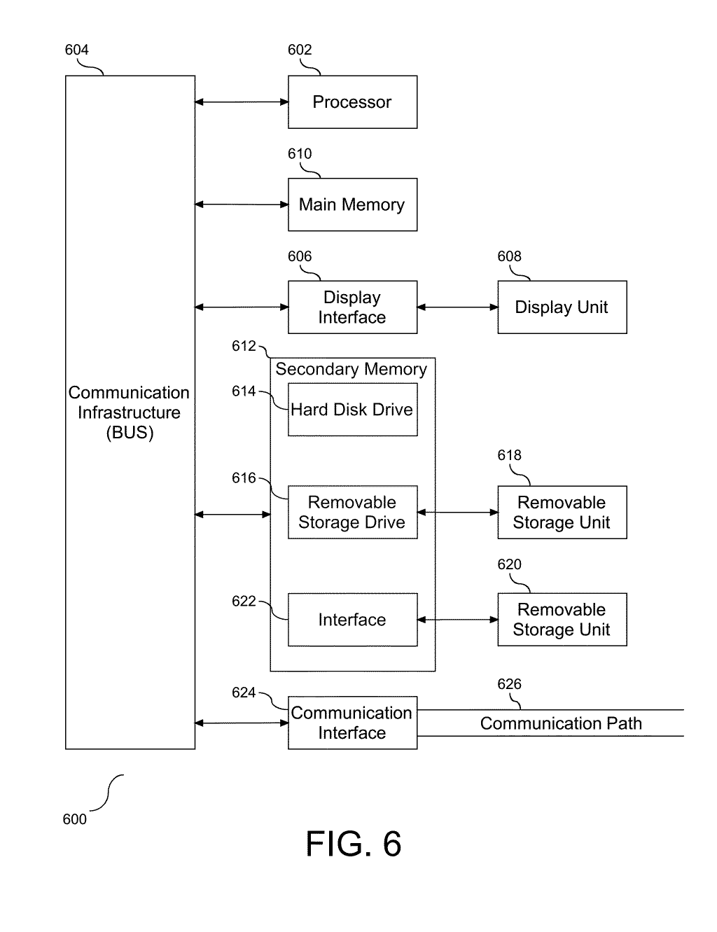

Referring now to the block diagram (600) of FIG. 6, additional details are now described with respect to implementing an embodiment of the present invention. The computer system includes one or more processors, such as a processor (602). The processor (602) is connected to a communication infrastructure (604) (e.g., a communications bus, cross-over bar, or network).

The computer system can include a display interface (606) that forwards graphics, text, and other data from the communication infrastructure (604) (or from a frame buffer not shown) for display on a display unit (608). The computer system also includes a main memory (610), preferably random access memory (RAM), and may also include a secondary memory (612). The secondary memory (612) may include, for example, a hard disk drive (614) (or alternative persistent storage device) and/or a removable storage drive (616), representing, for example, a floppy disk drive, a magnetic tape drive, or an optical disk drive. The removable storage drive (616) reads from and/or writes to a removable storage unit (618) in a manner well known to those having ordinary skill in the art. Removable storage unit (618) represents, for example, a floppy disk, a compact disc, a magnetic tape, or an optical disk, etc., which is read by and written to by a removable storage drive (616). As will be appreciated, the removable storage unit (618) includes a computer readable medium having stored therein computer software and/or data.

In alternative embodiments, the secondary memory (612) may include other similar means for allowing computer programs or other instructions to be loaded into the computer system. Such means may include, for example, a removable storage unit (620) and an interface (622). Examples of such means may include a program package and package interface (such as that found in video game devices), a removable memory chip (such as an EPROM, or PROM) and associated socket, and other removable storage units (620) and interfaces (622) which allow software and data to be transferred from the removable storage unit (620) to the computer system.

The computer system may also include a communications interface (624). Communications interface (624) allows software and data to be transferred between the computer system and external devices. Examples of communications interface (624) may include a modem, a network interface (such as an Ethernet card), a communications port, or a PCMCIA slot and card, etc. Software and data transferred via communications interface (624) are in the form of signals which may be, for example, electronic, electromagnetic, optical, or other signals capable of being received by communications interface (624). These signals are provided to communications interface (624) via a communications path (i.e., channel) (626). This communications path (626) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (610) and secondary memory (612), removable storage drive (616), and a hard disk installed in hard disk drive or alternative persistent storage device (614).

Computer programs (also called computer control logic) are stored in main memory (610) and/or secondary memory (612). Computer programs may also be received via a communication interface (624). Such computer programs, when run, enable the computer system to perform the features of the present invention as discussed herein. In particular, the computer programs, when run, enable the processor (602) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Alternative Embodiment

It will be appreciated that, although specific embodiments of the invention have been described herein for purposes of illustration, various modifications may be made without departing from the spirit and scope of the invention. In one embodiment, one or more scripts are utilized to automate the risk assessment. As risk assignments change, the scripts dynamically perform the assessment and evaluation to identify area that will be mitigated against risk. In one embodiment, the risk evaluation may be applied to process development, and specifically changes in phases of a process. Each phase may have risk criteria associated therewith, including but not limited to value add, non-value add, criticality, etc. The risk criteria may be applied to the different phases so that assessment and evaluation of the risks may identify processes or sub-processes that may be mitigated against risk. Accordingly, the scope of protection of this invention is limited only by the following claims and their equivalents.

We claim:

1. A method comprising:
identifying one or more functional items that comprise an entity;
evaluating each of the functional items against a plurality of criteria;
assigning a numerical value to each of the criteria evaluated;
assessing a risk priority number to each of the functional items, the risk priority number based on a combination of the numerical value for each of the plurality of criteria for each functional item;
ranking each of the functional items based on the risk priority number, including sorting the functional items based on the ranking; and
providing an inclusive view of entity risk, including categorizing the elements into groups and identifying at least one area for risk mitigation.

2. The method of claim 1, further comprising changing the numerical value of at least one of the criteria evaluated, and wherein the changed value includes reassessing the risk priority number.

3. The method of claim 2, further comprising re-ranking the functional items that comprise the entity based on the changed numerical value of at least one of the evaluated criteria.

4. The method of claim 1, wherein assigning the numerical value to each of the criteria includes independently assigning a separate risk value to each of the criteria.

5. The method of claim 1, wherein each of the plurality of criteria are stored in a separate database, and wherein evaluating the functional elements against the criteria includes pulling disparate data from different databases.

6. The method of claim 5, further comprising running a series of scripts to quantify one or more risks.

7. The method of claim 1, wherein the inclusive view supports historical and comparative assessment of individual risks to the separate functional items.

8. A computer program product to perform risk analysis, the computer program product comprising a computer-readable storage device having computer readable program code embodied therewith, the program code executable by a processor to:
identify one or more functional items that comprise an entity, and evaluate each of the functional items against a plurality of criteria;
assign a numerical value to each of the criteria evaluated;
assess a risk priority number to each of the functional items, the risk priority number based on a combination of the numerical value for each of the plurality of criteria for each functional item;
rank each of the functional items based on the risk priority number, including sorting the functional items based on the ranking; and
provide an inclusive view of entity risk, including categorizing the elements into groups and identifying at least one area for risk mitigation.

9. The computer program product of claim 8, further comprising code to change the numerical value of at least one of the criteria evaluated, and wherein the changed value includes reassessing the risk priority number.

10. The computer program product of claim 9, further comprising code to re-rank the functional items that comprise the entity based on the changed numerical value of at least one of the evaluated criteria.

11. The computer program product of claim 8, wherein the code to assign the numerical value to each of the criteria includes independent assignment of a separate risk value to each of the criteria.

12. The computer program product of claim 8, wherein each of the plurality of criteria are stored in a separate database, and wherein evaluating the functional elements against the criteria includes pulling disparate data from different databases.

13. The computer program product of claim 12, further code to run a series of scripts to quantify one or more risks.

14. The computer program product of claim 8, wherein the inclusive view supports historical and comparative assessment of individual risks to the separate functional items.

15. A system comprising:
a processing unit in communication with memory;
one or more tools in communication with memory, the tools to perform element risk analysis, the tools comprising:
an identification manager to identify one or more functional items that comprise an entity, evaluate each of the functional items against a plurality of criteria, and assign a numerical value to each of the criteria evaluated;
an assessment manager to assess a risk priority number to each of the functional items, the risk priority number based on a combination of the numerical value for each of the plurality of criteria for each functional item, and to rank each of the functional items based on the risk priority number, including sorting the functional items based on the rank; and
an inclusive view of entity risk provided by the assessment manager, including a categorization of the elements into groups and identification of at least one area for risk mitigation.

16. The system of claim 15, further comprising the assessment manager to change the numerical value of at least one of the criteria evaluated, and wherein the changed value includes reassessment of the risk priority number.

17. The system of claim 16, further comprising the assessment manager to re-rank the functional items that comprise the entity based on the changed numerical value of at least one of the evaluated criteria.

18. The system of claim 15, wherein assignment of the numerical value to each of the criteria includes independently assigning a separate risk value to each of the criteria.

19. The system of claim 15, further comprising the assessment manager to run a series of scripts to quantify one or more risks.

20. The system of claim 15, wherein the inclusive view supports historical and comparative assessment of individual risks to the separate functional items.
